(19) United States
(12) Patent Application Publication
(10) Pub. No.: US 2024/0167802 A1
(43) Pub. Date: May 23, 2024

(54) Compact Deformation Detection Device for an Energy Store

(71) Applicant: Bayerische Motoren Werke Aktiengesellschaft, Muenchen (DE)

(72) Inventors: Florian ACHATZ, Muenchen (DE); Clemens BERGMANN, Muenchen (DE); Felix BILGER, Muenchen (DE); Ralph NIESSEN, Kranzberg (DE); Philipp Alexander ROTH, Muenchen (DE)

(21) Appl. No.: 18/283,859

(22) PCT Filed: Feb. 28, 2022
(86) PCT No.: PCT/EP2022/054956

§ 371 Date: Sep. 25, 2023

(30) Foreign Application Priority Data
Mar. 26, 2021 (DE) 10 2021 107 733.8

(51) Int. Cl. G01B 7/16; B60L 3/00; H01M 10/48

(52) U.S. Cl. CPC G01B 7/22; B60L 3/0046; H01M 10/488; B60L 2250/16; H01M 2220/20

(57) ABSTRACT

A deformation detection device and method for an energy storage assembly integrated in a vehicle support structure of a motor vehicle having an energy store and a housing structure, includes an outer sensing element which is formed as or on an outer housing structure element, an inner sensing element which is formed as or on an inner energy storage element, and an evaluation unit which is designed to detect a change in an electrical operating parameter.

### BACKGROUND AND SUMMARY

The invention relates to a deformation detection device for an energy storage assembly integrated in a vehicle support structure of a motor vehicle, and to a vehicle information system and an energy storage assembly having such a deformation detection device. In addition, the invention relates to a method for the detection of a deformation of an energy storage assembly.

For structurally integrated high-voltage stores as a typical design of an energy store group, the installation space available in the vehicle vertical direction is highly restricted. In order to arrange an adequate quantity of energy storage cells in this restricted installation space, it is necessary to utilize the installation space as best as possible, in particular in the vehicle vertical direction. At the same time, however, adequate robustness of the high-voltage store with respect to mechanical stresses from outside must be ensured, in particular including with respect to stresses introduced via functional chains that are specific to the entire vehicle. For a long time, this conflict of objectives could be resolved only via a mechanical damage chain in which, in the event of mechanical over-stressing of the entire vehicle, peripheral and/or sacrificial components fail deliberately in order to protect the supporting structural components by means of the dissipation of energy achieved thereby.

DE 10 2018 200 919 A1 discloses a detection device for detecting mechanical deformation of a high-voltage store of a motor vehicle, comprising: a sensor element which detects an electrical measured variable, wherein the sensor element is a substantially flat design and is at least partly attached to a first component of the high-voltage store, and an evaluation device for analyzing the electrical measured variable between the sensor element and a second component of the high-voltage store and for outputting a corresponding warning message based on the electrical measured variable, at least one region of the upper surface of the second component being electrically conductive.

Against this background, it is an object of the invention to improve deformation detection for an energy storage assembly.

This object is achieved by a deformation detection device, a vehicle information system, an energy storage assembly, a motor vehicle, and a method for the detection of a deformation of an energy storage assembly, in accordance with the independent claims. The dependent claims relate to advantageous developments of the invention.

One aspect discloses a deformation detection device for an energy storage assembly integrated in a vehicle support structure of a motor vehicle and having an energy store and a housing structure. The deformation detection device has at least the following:
(a) an outer, electrically conductive sensing element which is formed as or on or with an outer housing structure element, in particular therefore bonded thereto, integrated therein and/or in one piece or identical thereto;
(b) an inner, electrically conductive sensing element, which is formed as or on (i.e. with and/or on top of) an inner energy store element, in particular therefore bonded thereto, integrated therein and/or formed in one piece therewith or identical thereto, and, in regular vehicle operation, is arranged at a constant distance from the outer sensing element. For example, the inner sensing element may be the cell contacting system of all or some of the energy storage cells or be part thereof;
c) an evaluation unit, which is set up to detect a change, in particular a reduction, of an electrical operating parameter, in particular a capacitance and/or a charge, of a capacitor formed by the inner sensing element and the outer sensing element, resulting in particular from a deformation and/or displacement (in relation to the inner sensing element) of the outer sensing element. The detection can in particular be carried out indirectly, by a voltage present on the capacitor being detected and evaluated.

A detection of any relevant deformation of the energy store, specifically its lower housing structure, is therefore possible. In contrast to the known solutions, it is therefore possible not just for a serious defect to be detected but also slight deformations, which makes possible a finely structured reaction logic to different levels of the damage to the lower housing structure and possibly also to the energy store itself.

The energy storage assembly in the present case is in particular an electric traction battery having a plurality of battery modules and/or cells, which are accommodated with a battery management system in a load-bearing housing.

The term “energy store integrated in a vehicle support structure” is in particular to be understood as an energy store the housing of which, in addition to the functions of protection of the energy storage cells and of the battery management against environmental influences and the surroundings against the stored electrical and/or thermal energy, is also designed and set up to bear and/or to absorb loads from a weight and/or vehicle dynamics and/or a crash contact of the vehicle and/or to support them with respect to other support components.

In the present case, an external housing structure element is in particular to be understood as a constituent part of a lower housing structure of the energy store. In particular, the outer housing structure element is shell-like and/or trough-like and/or in the form of a shear box. According to one embodiment, the outer sensing element is embodied by the outer housing structure element. According to another embodiment, the outer sensing element is applied to the outer housing structure element, for example in the form of a printed and bonded-on conductor track.

According to one embodiment, at least one electrically insulating component is arranged between the outer and the inner sensing element of the capacitor in order to ensure the field structure. In addition, a damping material, such as a suitable hardened foam for example, can be provided between the outer and the inner sensing element of the capacitor, to absorb load in the event of a deformation. The energy store itself is in particular a high-voltage store in the vehicle, for example in the sense of a traction battery. The energy store has in particular a plurality of electrochemical battery cells wired in series and/or parallel with one another and/or can be built up from a plurality of battery modules wired in series and/or parallel with one another and having a plurality of battery cells.

For example, the damping material occupies a large part or the whole of the space between the outer and the inner sensing element of the capacitor. As a result of the load-bearing ability of the damping material, the dimensioning of the capacitor in the vehicle vertical direction can be reduced further.

According to one embodiment, the sensing elements and the electrically insulating component are arranged alternately in parallel with one another, wherein the electrically insulating component can be arranged at a distance from the two sensing elements, for example centrally, and/or surrounded by the damping material.

According to one embodiment, the outer sensing element is part of a lower housing structure in the vehicle vertical direction of the energy storage assembly, in order to save further installation space in the vehicle vertical direction.

A further aspect of the invention discloses a vehicle information system which, in particular, has a deformation detection device according to one embodiment of the invention and an output means, which is set up and designed to output information to at least one vehicle user. The output means is additionally set up to output an in particular reliably perceptible warning message to a vehicle occupant, in particular a driver and/or other occupants, and/or to the surroundings of a vehicle, in the event of a field change limiting value being exceeded, in particular a limiting value for a change in the electrical operating parameter of the capacitor formed by the inner and the outer sensing element.

As a result, the consequences of damage to the energy storage assembly can be minimized, specifically with regard to personal damage but possibly also with regard to property damage, in particular by the warning message advising an immediate workshop visit or parking the vehicle as quickly as possible in an empty open space or leaving the damaged vehicle immediately.

In particular, the warning message is output following corresponding actuation by means of the evaluation unit. In particular, exceeding the limiting value represents a presumed exceeding of a mechanical loadbearing capacity of the energy storage assembly, for which reason the limiting value is set at the selected level.

In particular, the output means is set up to output the warning message in such a way that perception of the message by the envisaged receiver or receivers is ensured, for example by the warning means having a screen and/or a loudspeaker and/or a warning lamp and/or a haptic warning device, in particular integrated in the steering wheel of the vehicle.

A further aspect of the invention discloses an energy storage assembly for a motor vehicle, having a deformation detection device according to an embodiment of the invention.

A further aspect of the invention discloses a motor vehicle having an energy storage assembly which is part of a vehicle support structure of the motor vehicle. The motor vehicle in particular has a vehicle information system according to one embodiment of the invention.

A further aspect of the invention discloses a method for the detection of a deformation of an energy storage assembly which, in particular, is designed according to an embodiment of the invention. The method has at least the following method steps:
(i) monitoring an electrical parameter of a capacitor formed by the inner and the outer sensing element;
(ii) comparing a sensed change in the electrical parameter with a limiting value which is representative of a potentially damaging deformation;
(iii) outputting a warning to a vehicle occupant and/or the vehicle surroundings if the limiting value is exceeded.

The method makes use of the fact that when a mechanical loading limit of the electrical contacting means for the evaluation unit is exceeded, the electrical field of the capacitor which is formed by the inner and the outer sensing element has a known electrical field strength, which changes measurably in a predetermined way in the event of a determined deformation (for example of different intensity and/or at a different point). The field change can be measured via a change in the electrical voltage between the two sensing elements. The field change is predetermined, for example, when data is entered into a characteristic map for different operating states and/or different deformations of the energy storage assembly by means of trials during the vehicle development.

According to one embodiment, the evaluation unit is set up to apply an electrical field of known electrical field strength between the two sensing elements and/or to detect an in particular unforeseen change of an electrical field present between the two sensing elements, in particular in the event of a mechanical loadbearing limit of the lower housing structure of the component integrated into the vehicle structure being exceeded in an intended operating state of the motor vehicle.

As a result, even extremely small deformations and/or displacements of the outer sensing element can be detected. In particular, with a change in the space between the two sensing elements, their mutual electrical potential changes. The potential change can be measured by the evaluation unit by means of a voltage sensor.

In particular, the evaluation unit is set up to detect and/or to evaluate variations of an electrical voltage which is present on the capacitor and, in particular, a change thereof, since changes in the capacitance and/or the charge of the capacitor (and therefore deformations) can be detected thereby.

According to one embodiment, the evaluation unit is set up to detect a deformation in the event of a field change limiting value being exceeded. As a result, field changes resulting from dynamic loads from regular driving operation can be differentiated from damage events.

According to one embodiment, the evaluation unit is set up to detect a permanent deformation if, following a detected field change, a new field strength that is constant and different from the old field strength is established.

This permits a distinction to be drawn between elastic and plastic deformations of the outer sensing element. In the case of an elastic deformation of the outer sensing element, according to one embodiment an at most elastic deformation of the inner sensing element can also be assumed.

According to one embodiment, the evaluation unit has damage determination logic, which is set up to assign differently intense and/or differently localized and/or differently long-lasting changes in the detected field strength to different damage classes.

In particular, provision is made for different field change limiting values to be stored in the evaluation unit and/or to be assigned to a damage class which is higher, the higher an exceeded field change limiting value is.

This permits a more accurate failure prognosis and therefore an operation of the energy store that is safer for the vehicle user and/or surroundings with, at the same time, a lower installation space needed in the vehicle vertical direction.

According to one embodiment, an in particular mechanical intended fracture point for its electrical conductivity is arranged on the inner sensing element, being designed in such a way that at a predetermined load-bearing capacity limit, it triggers protection for the surroundings of the energy store, in particular fails mechanically while losing the electrical contact effect.

In particular if the inner sensing element is formed with an electrical contacting means for at least one electrical energy storage unit of the energy store, automatic electrical decoupling of the energy storage unit, possibly of the entire energy store can be achieved automatically as a result; otherwise an unequivocally measurable change in the electrical field tapped off at the evaluation unit.

According to one embodiment, the deformation detection device has two or more capacitors that can be sensed separately by means of the evaluation unit, which are each formed by means of an inner sensing element and by means of an outer sensing element, and the arrangement areas of which, in particular based on an extent in a horizontal vehicle plane, differ from one another with regard to an extent along a vehicle longitudinal direction and/or along a vehicle transverse direction.

Therefore, a spatially more detailed statement about a damage class to be assigned can be made. The damage class to be assigned can also be directed to local differences in the loadbearing ability of the energy store. It is therefore possible to take account of the fact that the same introduction of load at a first point of an energy store will possibly damage less than at another point.

The electrically insulating component can be formed in one piece despite the subdivision into a plurality of capacitors, or subdivided in a way analogous to the subdivision of the capacitors.

According to one embodiment, the capacitors and the electrically insulating component can be formed in a plurality of parts correlating with each other in segments, wherein if a mechanical loadbearing limit of the lower housing structure and/or a possibly associated field change limiting value for the evaluation unit is exceeded, the electric field of known electrical field strength changes measurably segment by segment.

According to one embodiment, the evaluation unit is a control device arranged in the energy storage assembly.

In particular, the evaluation unit can be designed as a logical and/or physical part of a battery management system.

As a result, a minimum requirement for installation space and/or integration of the deformation detection device can be ensured.

Further advantages and possible applications of the invention can be gathered from the following description in conjunction with the figures.

### BRIEF DESCRIPTION OF THE DRAWINGS

FIG. 1 is a schematic sectional view of an energy storage assembly with a deformation detection device according to an exemplary embodiment of the invention.

FIG. 2 is a schematic sectional view of an energy storage assembly with a deformation detection device according to another exemplary embodiment of the invention.

FIG. 3 shows method steps of an exemplary method for the detection of a deformation of the energy storage assembly from FIG. 1.

### DETAILED DESCRIPTION OF THE DRAWINGS

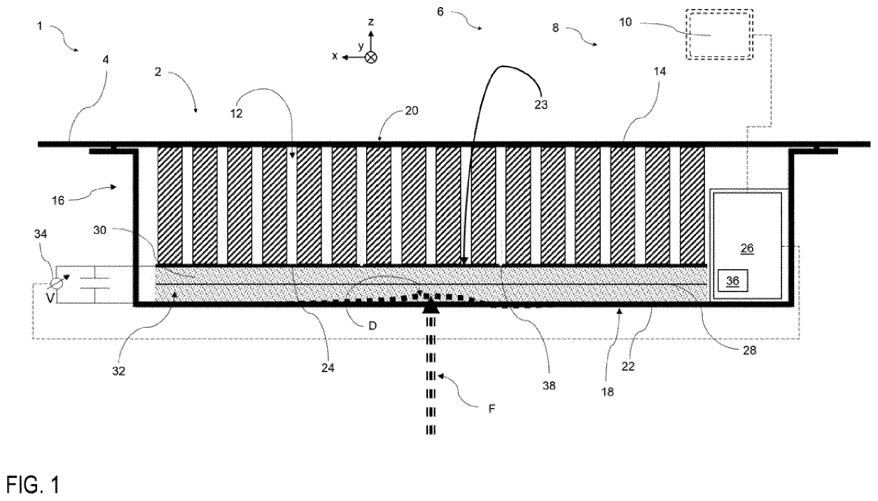

FIG. 1 shows a detail of a motor vehicle 1 which is constructed with an electric traction machine, not illustrated, for example a battery-electric (BEV) or plug-in hybrid (PHEV). As a traction battery for the electric drive machine, the motor vehicle 1 has an energy storage assembly 2, which is part of a vehicle support structure 4 of the motor vehicle, here the vehicle lower floor. The energy storage assembly 2 has an energy store 12 with a plurality of battery cells 14, round cells here, and a housing structure 16 with a housing trough 18 and a housing cover 20, which is formed by a vehicle floor component of the vehicle support structure 4. The housing trough 18 and the vehicle floor component of the vehicle support structure 4 are sealed off in a fluid-tight manner with respect to each other, so that to this extent the energy store is decoupled from the surroundings.

In addition, the motor vehicle 1 has a vehicle information system 6. The vehicle information system 6 has a deformation detection device 8 for the energy storage assembly 2 and an output device 10 for the deformation detection device 8.

The deformation detection device 8 has an outer, electrically conductive sensing element 22, which is formed by a metallic housing structure element, here a baseplate of the housing trough 18.

The deformation detection device 8 further has an inner, electrically conductive sensing element 24, which is formed by a cell contacting system 23 of the energy store 12 and therefore, in regular vehicle operation, is arranged at a constant distance from the outer sensing element 22.

An electrically insulating component 28, a dielectric film here, is arranged between the outer sensing element 22 and the inner sensing element 24. In addition, a damping material 30, here a suitable hardened foam, is arranged between the outer and the inner sensing element to absorb load in the event of a deformation.

The inner sensing element 24 and the outer sensing element 22, together with the electrically insulating component 28, therefore form a capacitor 32.

The deformation detection device 8 further has an evaluation unit 26, which is set up to detect a change of an electrical voltage V present on the capacitor.

Such a change can in particular result from a deformation D and/or displacement of the outer sensing element 22, which in turn is caused by the action of a force F from outside the vehicle, typically when the vehicle floor strikes a sharp or angular obstacle.

This permits detection of relevant deformations D of the energy storage assembly 2, specifically of the housing trough 18. As distinct from the known solutions, it is possible to detect not only serious defects but also slight deformations which possibly do not lead directly to a safety-critical failure of the energy storage assembly 2 but will be associated with a specific probability of subsequent failure, so that detection is desirable in order to be able to avert subsequent damage, if necessary by means of a check on the integrity of the energy storage assembly 2, for example a visual check in the workshop.

The use of a capacitor-based sensor can help to save installation space in a vehicle vertical direction z.

In the present case, in an intended state of the motor vehicle 1, an electric field of known electrical field strength is applied between the two sensing elements 22, 24. With a change in the spacing of the two sensor elements 22, 24, their mutual electrical potential changes. The potential change can be detected by means of a voltage sensor 34 and measured by the evaluation unit 26. As a result, even extremely small deformations D and/or displacements of the outer sensing element 22 can be detected.

In the present case, a deformation is detected if a first voltage limiting value which represents a specific strength of the field change on the capacitor 32 and therefore a specific type of deformation D is exceeded. As a result, field changes resulting from dynamic loads from regular driving operation can be distinguished from damage events.

The evaluation unit can be programmed in such a way that it sets a deformation flag only when a new field strength that is different from the old field strength is established following a detected field change. This permits a distinction to be drawn between elastic and plastic deformations of the outer sensing element.

In the present case, the evaluation unit 26 has damage determination logic 36, by means of which changes of different intensity in the detected voltage V can be assigned to differently intense deformations and therefore different damage classes. Therefore, different reactions of the vehicle information system 62 to different cases of damage can be activated.

For very severe deformations, provision can be made in the present case for the detection of the deformation and a safety measure for averting direct damage to be achieved by means of a combined mechanism: a mechanical intended fracture point 38 which fails mechanically at a predetermined loadbearing capacity limit with the loss of the electrical contact effect can be arranged on the inner sensing element 24, so that the energy storage cells are no longer incorporated in the drive power circuit, since the inner sensing element 24 is formed in the cell contacting system 23.

The output device 10 is set up to output a warning message to a vehicle occupant and/or a vehicle surroundings, for example by means of a combined audio and screen warning message M, if a voltage limiting value V_G is exceeded, with corresponding activation by the evaluation unit 26. The screen warning message in the present case contains handling instructions, which can differ depending on the location or the gravity of the detected deformation D.

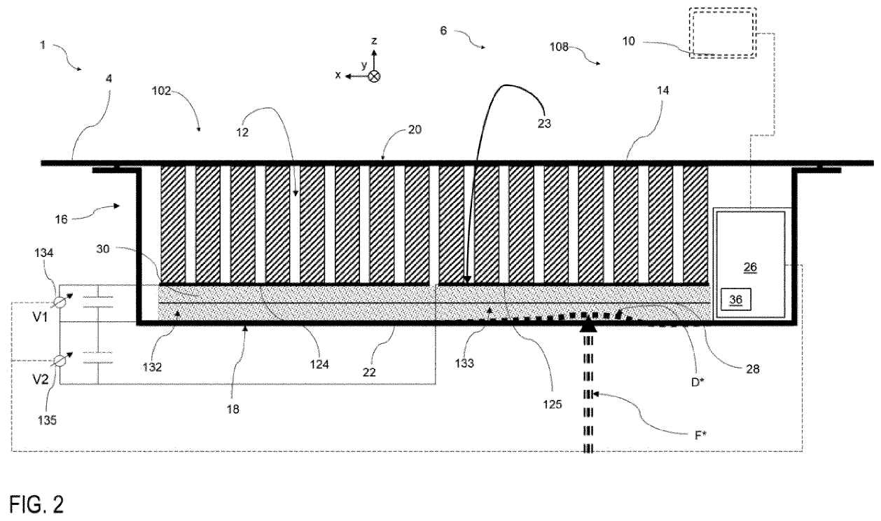

FIG. 2 illustrates an energy storage assembly 102, which differs from the energy storage assembly 2 of FIG. 1 in that a plurality of capacitors 132, 133 are formed, in order to permit locally finer detection of the deformation D* which results from the action of a force F*.

To this end, the deformation detection device 108 has a plurality of inner sensing elements 124, 125 which are separated electrically from one another and of which the arrangement areas differ from one another with regard to an extent along a vehicle longitudinal direction x and/or along a vehicle transverse direction y.

Because the electrical voltages V1 of the capacitor 132 and V2 of the capacitor 133 are monitored and evaluated separately by means of voltage sensors 134, 135, a spatially more detailed statement about a damage class to be assigned can be made, in the present case including the statement that the deformation D* occurs in the arrangement area of the capacitor 133.

The electrically insulating component 28 and the outer sensing element 24 can each be formed in one piece, irrespective of the subdivision into a plurality of capacitors 132, 133.

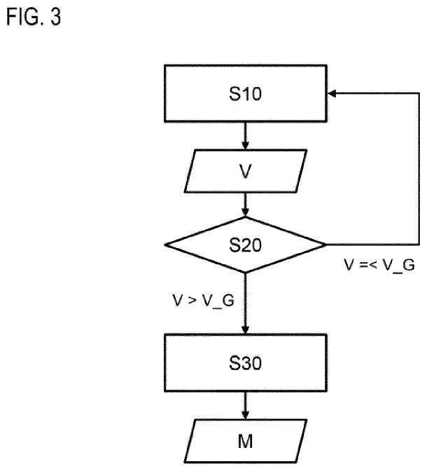

FIG. 3 shows method steps of an exemplary method for the detection of a deformation of the energy storage assembly 2 from FIG. 1.

In step S10, an electrical operating parameter V of a capacitor 32 formed by the inner sensing element 24 and the outer sensing element 26 is monitored.

In step S20, a sensed change in the electrical operating parameter V is compared with a limiting value V_G which is representative of a potentially damaging deformation D.

In step S30, the limiting value V_G is exceeded, a warning message M is output to a vehicle occupant and/or the vehicle surroundings.

If the limiting value V_G is not exceeded, the electrical operating parameter V continues to be monitored in the sense of step S10, and step S20 is carried out again—possibly with a predetermined time offset.

### LIST OF DESIGNATIONS

1 Motor vehicle
2, 102 Energy storage assembly
4 Vehicle support structure
6 Vehicle information system
8, 108 Deformation detection device
10 Output means
12 Energy store
14 Battery cell
16 Housing structure
18 Housing trough
20 Housing cover
22 Outer sensing element
23 Cell contacting system
24, 124, 125 Inner sensing element
26 Evaluation unit
28 Electrically insulating component
30 Damping material
32, 132, 133 Capacitor
34, 134, 135 Voltage sensor
36 Damage determination logic
38 Mechanical intended fracture point
D, D* Deformation
F, F* Action of force
M Warning message
V Electrical voltage
V_G Limiting value of the electrical voltage

1.-12. (canceled)

13. A deformation detection device for an energy storage assembly of a motor vehicle, comprising:
an outer sensing element, which is formed as, or on, an outer housing structure of the energy storage assembly;
an inner sensing element, which is formed as, or on, an inner energy storage element of the energy storage assembly; and
an evaluation unit configured to detect a change of an electrical operating parameter of a capacitor formed by the inner sensing element and the outer sensing element.

14. The deformation detection device according to claim 13, wherein the evaluation unit is further configured to:
apply an electric field of known electric field intensity between the inner and the outer sensing elements in an intended operating state of the motor vehicle; and/or
detect a change of an electrical field present between the inner and the outer sensing elements.

15. The deformation detection device according to claim 14, wherein the evaluation unit is further configured to:
detect a deformation when a limiting value is exceeded.

16. The deformation detection device according to claim 14, wherein the evaluation unit is further configured to:
detect a permanent deformation when, following a detected change of the electrical field, a new field strength that is constant and different from the old field strength is established.

17. The deformation detection device according to claim 14, wherein the evaluation unit comprises damage determination logic, which is configured to assign different damage classes to different changes in strength of the electric field.

18. The deformation detection device according to claim 13, wherein
an intended fracture point with respect to electrical conductivity is arranged on the inner sensing element, the fracture point being configured so as to trigger at a predetermined loadbearing ability limit.

19. The deformation detection device according claim 13, wherein
two or more capacitors are provided that are sensible separately, arrangement areas of which differ from each other with regard to an extent along a vehicle longitudinal direction and/or along a vehicle transverse direction.

20. The detection device according to claim 13, wherein the evaluation unit is an electronic control unit arranged in the energy storage assembly.

21. A vehicle information system, comprising:
a deformation detection device according to claim 15; and
an output device configured to output a warning message to a vehicle occupant and/or vehicle surroundings when a limiting value is exceeded.

22. An energy storage assembly for a motor vehicle, comprising:
an outer housing structure of the energy storage assembly;
an inner energy storage element of the energy storage assembly;
an outer sensing element, which is formed as, or on, the outer housing structure of the energy storage assembly;
an inner sensing element, which is formed as, or on, the inner energy storage element; and
an evaluation unit configured to detect a change of an electrical operating parameter of a capacitor formed by the inner sensing element and the outer sensing element.

23. A motor vehicle, comprising:
an energy storage assembly according to claim 22; and
an output device of a vehicle information system, the output device being configured to output a warning message to a vehicle occupant and/or vehicle surroundings when a limiting value is exceeded.

24. A method for detecting a deformation of an energy storage assembly of a motor vehicle, comprising:
monitoring an electric operating parameter of a capacitor formed by an inner sensing element, formed as, or on, an inner energy storage element of the energy storage assembly and an outer sensing element, formed as, or on, an outer housing structure of the energy storage assembly;
comparing a sensed change of an electrical operating parameter of the capacitor formed by the inner and outer sensing elements with a limiting value which is representative of a potentially damaging deformation; and
outputting a warning to a vehicle occupant and/or the vehicle surroundings when the limiting value is exceeded.
